(19) United States
(12) Patent Application Publication
(10) Pub. No.: US 2022/0307357 A1
(43) Pub. Date: Sep. 29, 2022

(54) RESERVOIR FLUID PROPERTY MODELING USING MACHINE LEARNING

(71) Applicant: LANDMARK GRAPHICS CORPORATION, HOUSTON, TX (US)

(72) Inventors: Ajay Pratap Singh, Houston, TX (US); Suryansh Purwar, Houston, TX (US); Ashwani Dev, Katy, TX (US); Satyam Priyadarshy, Herndon, VA (US)

(21) Appl. No.: 17/293,454

(22) PCT Filed: Jun. 12, 2020
(86) PCT No.: PCT/US2020/037587

§ 371 Date: May 12, 2021

(51) Int. Cl. E21B 43/16; E21B 47/06; E21B 47/003

(52) U.S. Cl. CPC E21B 43/16; E21B 47/06; E21B 47/003; E21B 2200/20

(57) ABSTRACT

System and methods for tuning equation of state (EOS) characterizations are presented. Pressure-volume-temperature (PVT) data is obtained for downhole fluids within a reservoir formation. A component grouping for an EOS model of the downhole fluids is determined, based on the obtained PVT data. The component grouping is used to estimate properties of the downhole fluids for a current stage of a downhole operation within the formation. A machine learning model is trained to minimize an error between the estimated properties and actual fluid properties measured during the current stage of the operation, where the component grouping for the EOS model is iteratively adjusted by the machine learning model until the error is minimized. The EOS model is tuned using the adjusted component grouping. Fluid properties are estimated for one or more subsequent stages of the downhole operation to be performed along the wellbore, based on the tuned EOS model.

### FIELD OF THE DISCLOSURE

The present disclosure relates generally to reservoir fluid modeling for hydrocarbon exploration and production and particularly, to reservoir fluid modeling using equation of state (EOS) characterizations of reservoir fluids.

### BACKGROUND

An equation of state (EOS) model including different EOS characterizations of fluids (e.g., oil and gas) within a reservoir rock formation may be used to simulate the behavior of those fluids for hydrocarbon exploration and production. The fluid composition of a hydrocarbon reservoir within a subsurface rock formation may have a significant influence on the recovery of hydrocarbons from the reservoir. Equation of state (EOS) characterizations of the reservoir's fluids may be used with pressure, volume and temperature (PVT) equations to identify PVT correlations and predict the fluid properties of the reservoir. Examples of fluid properties that may be predicted using such an EOS model include, but are not limited to, viscosity, density, formation volume factor, and fluid phase properties (e.g., the number of fluid phases as well as the density and composition of each phase). The EOS model may be used in a reservoir simulator to predict fluid properties and simulate fluid flow within the reservoir.

There may be significant variation in a reservoir's fluid composition and PVT properties (e.g., formation factors, density, viscosity etc.). Therefore, a relatively accurate EOS model that captures both the compositional variation and variation of PVT properties within the reservoir may be needed for the simulation to be effective. The accuracy of an EOS model may be improved by using PVT lab tests, based on fluid samples collected from the actual reservoir at various depths. The results of such lab tests may be used to optimize or “tune” the EOS model such that any error between the fluid properties predicted using the EOS model and those derived from the PVT lab tests is minimized.

However, reservoir fluids may contain thousands of components, and it may be impractical to determine the properties for all of them. Therefore, EOS models typically represent only a reduced set of fluid components in a reservoir. The number of fluid components represented by an EOS model may be reduced by grouping (or “lumping”) components together into pseudo-components. Each pseudo-component may be used to provide an EOS characterization for a group of fluid components based on one or more of their PVT properties, e.g., lumping all components that fall within a certain range of molecular weights. Reducing the number of components also reduces the accuracy of the model, e.g., as measured by a fitting error between the fluid properties estimated using the EOS model and those determined from PVT lab tests. Although increasing the number of components or component groups may decrease the EOS model's fitting error, having more components may increase the computing requirements and time needed for the simulation and fluid property calculations. Furthermore, it may be difficult to determine the appropriate number of components to use for the simulation and how such components should be grouped so as to improve the prediction capability of the EOS model without negatively impacting computing resources and system performance.

### BRIEF DESCRIPTION OF THE DRAWINGS

FIG. 1 is a perspective view of an illustrative hydrocarbon producing field with multiple production wells located at various wellsites throughout the field.

FIG. 2 is a block diagram of an illustrative computer system for tuning an equation of state (EOS) model of reservoir fluids for reservoir simulation and well planning with respect to various wellsites in the hydrocarbon producing field of FIG. 1.

FIG. 3 is a plot of illustrative fitting, validation, and total error trends for tuning an equation of state (EOS) model of reservoir fluids as a function of the number of fluid components and type of component grouping used in the tuning process.

FIG. 4 is a schematic of a reservoir having gas and oil zones from which fluid samples may be collected for validating an EOS model using PVT lab tests.

FIG. 5 is a diagram of an illustrative machine learning model in the form of an artificial neural network with multiple layers and nodes.

FIG. 6 is a flowchart of an illustrative process of optimizing EOS models with machine learning for improved reservoir flow simulations and prediction of reservoir fluid properties.

FIG. 7 is a block diagram of an illustrative computer system in which embodiments of the present disclosure may be implemented.

### DESCRIPTION OF ILLUSTRATIVE EMBODIMENTS

Embodiments of the present disclosure relate to optimizing or tuning equation of state (EOS) fluid models using machine learning for improved reservoir flow simulations and prediction of reservoir fluid properties. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to implement such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

As will be described in further detail below, embodiments of the present disclosure may be used to optimize or “tune” an EOS model of hydrocarbon fluids in a subsurface reservoir formation for improved simulation of fluid flow behavior in the reservoir and prediction of reservoir fluid properties. The EOS model may include, for example, multiple fluid characterizations in the form of lumped or grouped components or pseudo-components for different types of reservoir fluids (e.g., oil and gas) in addition to a set of pressure, volume and temperature (PVT) equations for correlating fluid properties with changes in pressure, volume and temperature as a function of depth or location within the reservoir formation. Such fluid properties may include, for example and without limitation, density, viscosity, bubble/dew points, formation volume factor and other oil/gas formation factors and their variation with pressure. Variations in these fluid properties may be caused by various factors or conditions within the formation including, for example, gravity segregation, thermal diffusion, convection, and any other condition present in the reservoir, which may affect downhole fluid flow. For example, gravity segregation in particular may cause heavier fluid components to settle down at greater depths within the reservoir formation.

In one or more embodiments, machine learning and statistics may be used to determine optimal component groups and EOS tuning parameters that minimize an objective function for tuning the EOS model. Examples of EOS tuning parameters may include, but are not limited to, binary interaction coefficients and critical PVT values for selected heavy components of reservoir fluids. The objective function may represent a total error between fluid properties estimated using the EOS model being tuned and actual properties observed or measured from PVT lab tests and/or fluid samples collected downhole at one or more wellsites in a hydrocarbon producing field. Examples of PVT lab tests that may be performed include, but are not limited to, a constant composition experiment (CCE), a differential liberation (DL) test, a separator test, a swell test, and a constant volume depletion (CVD) test. The total error may be calculated as the sum of a fitting error and a validation error. The fitting error may represent how well the estimated or modeled fluid properties match the PVT lab test data. The validation error may represent how well the estimated/modeled fluid properties match actual fluid properties measured by downhole sensors or other measurement devices at the wellsite(s) in the field. Such measurement devices may include, for example, downhole sensors coupled to a drill string disposed within a wellbore drilled within the reservoir formation. In one or more embodiments, the number of component groups (and/or fluid components within each group) and EOS parameters that define the EOS model may be iteratively adjusted as part of a reservoir simulation until the total error of the estimated or predicted fluid properties produced by the EOS model is minimized, e.g., falls below a predetermined error threshold. In this way, an optimal component grouping, including an optimal set of fluid components, component groups and tuning parameters, may be determined for the EOS model such that the model is tuned to capture both the compositional variation and the variation fluid properties (formation factors, density, viscosity etc.) within the reservoir formation, e.g., for purposes of reservoir flow simulations and well planning (or placement) during downhole operations, e.g., drilling, production and/or stimulation (e.g., secondary recovery) operations.

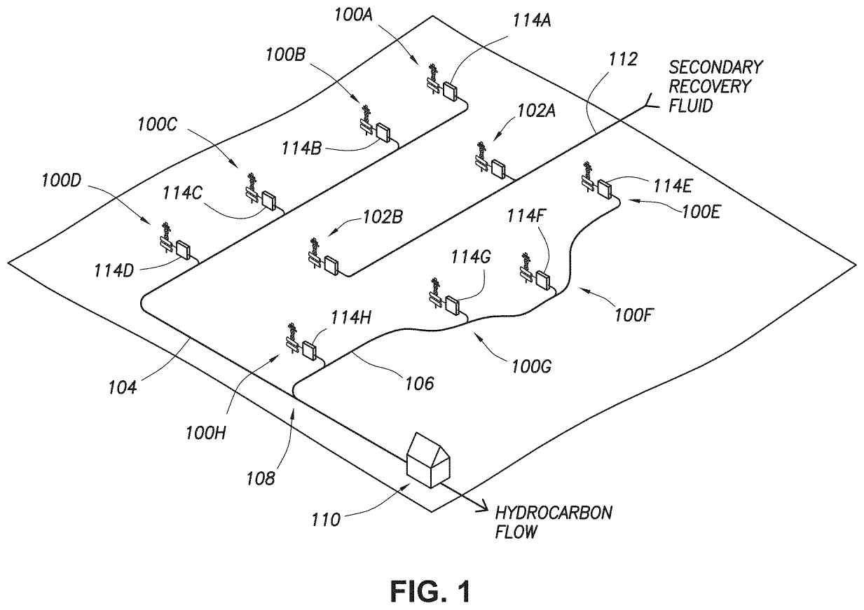

Illustrative embodiments and related methodologies of the present disclosure are described below in reference to FIGS. 1-7 as they might be employed in, for example, a computer system for well planning and control during downhole operations at one or more wellsites within a hydrocarbon producing field. Advantages of the disclosed EOS tuning techniques include, for example and without limitation, broad applicability to any fluid system (e.g., black oil fluid systems and gas condensate reservoirs), reduced computational requirements (including reduced processing time and memory requirements) for estimating the optimal (e.g., minimum) number of fluid components required to model the PVT behavior and compositional variation of fluids during reservoir simulations, and improved accuracy of EOS models for estimating or predicting fluid properties during downhole operations.

Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 is a perspective view of a portion of a hydrocarbon producing field according to an embodiment of the present disclosure. As shown in FIG. 1, the hydrocarbon producing field includes a plurality of hydrocarbon production wells 100A to 100H (“production wells 100A-H”) drilled at various locations throughout the field for recovering hydrocarbons from a subsurface reservoir formation. The field also includes injection wells 102A and 102B (“injection wells 102A-B”) for stimulating hydrocarbon production through injection of secondary recovery fluids, such as water or compressed gas, e.g., carbon dioxide, into the subsurface formation. The location of each well in this example may have been set by a wellsite operator, e.g., according to a predetermined wellsite plan to increase the extraction of hydrocarbons from the subsurface reservoir formation. It should be noted that the number of wells shown in the hydrocarbon producing field of FIG. 1 is merely illustrative and that the disclosed embodiments are not intended to be limited thereto.

In order to gather the hydrocarbons produced from each well, the hydrocarbon field has one more production flow lines (or “production lines”). For example, a production line 104 may be used to gather hydrocarbons from production wells 100A-100D, and a production line 106 may be used to gather hydrocarbons from production wells 100E-100H. The production lines 104 and 106 tie together at a gathering point 108, and then flow to a metering facility 110.

In some cases, secondary recovery fluid is delivered to injection wells 102A and 102B by way of trucks. In some cases, the secondary recovery fluid may be delivered and pumped into the formation on a periodic basis (e.g., daily, weekly). As illustrated in FIG. 1, the second recovery fluid may be provided under pressure to injection wells 102A and 102B by way of pipes 112.

In one or more embodiments, production wells 100A-H may be associated with corresponding wellsite data processing devices 114A-H located at the surface of the respective wellsites. As will be described in further detail below, each of wellsite data processing devices 114A-H may be used to process and store pressure, volume and temperature data collected by various downhole and/or surface measurement devices at each wellsite.

In one or more embodiments, the information or measurements collected by the measurement device(s) at each wellsite may be processed and stored at a data store coupled to each of wellsite data processing devices 114A-H. In some implementations, the collected measurements from each measurement device may be provided to each of wellsite data processing devices 114A-H as a stream of data, which may be indexed as a function of time and/or depth before being stored. The indexed data may include, for example, measurements of various fluid properties in addition to measurements of various reservoir conditions and drilling parameters, e.g., drilling fluid pressure at the surface, flow rate of drilling fluid, and rotational speed of the drill string in revolutions per minute (RPM). The indexed data may be stored in any of various data formats. For example, real-time measurement-while-drilling (MWD) or logging-while-drilling (LWD) data may be stored in an extensible markup language (XML) format, e.g., in the form of wellsite information transfer standard markup language (WITSML) documents organized and/or indexed against time/depth. Other types of real-time data related to the stimulation, drilling or production operations at each wellsite may be stored in a non-time-indexed format, such as in a format associated with a particular relational database.

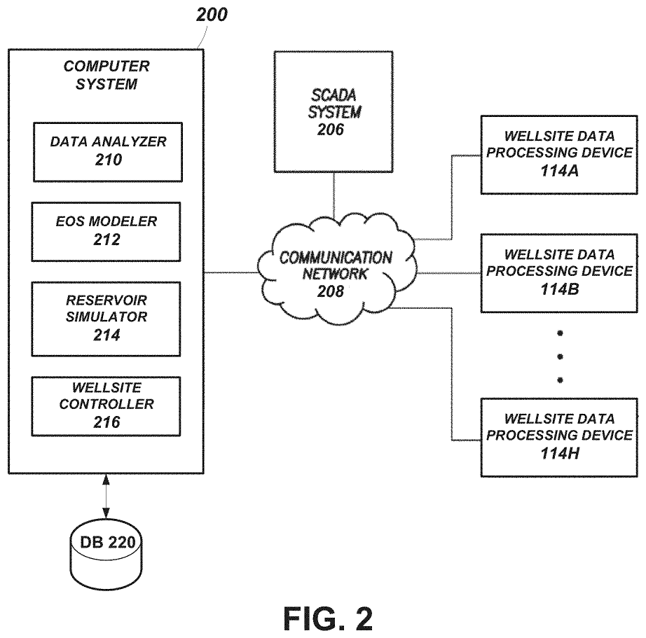

FIG. 2 is a block diagram of an illustrative computer system 200 for tuning an EOS model of reservoir fluids for performing reservoir simulation and well planning with respect to various wellsites in a hydrocarbon producing field, e.g., the hydrocarbon producing field of FIG. 1, as described above. As shown in FIG. 2, system 200 includes a data analyzer 210, an EOS modeler 212, a reservoir simulator 214, and a wellsite controller 216. System 200 may be implemented using any type of computing device having at least one processor and a memory. The memory may be in the form of a processor-readable storage medium for storing data and instructions executable by the processor. The storage medium may be, for example and without limitation, a semiconductor memory, a hard disk, or similar type of memory or storage device. Examples of such a computing device include, but are not limited to, a tablet computer, a laptop computer, a desktop computer, a workstation, a server, a cluster of computers in a server farm or other type of computing device. In some implementations, system 300 may be a server system located at a data center associated with the hydrocarbon producing field. The data center may be, for example, physically located on or near the field. Alternatively, the data center may be at a remote location away from the hydrocarbon producing field.

Also, as shown in FIG. 2, system 200 may be communicatively coupled via a communication network 208 to a supervisory control and data acquisition (SCADA) system 206 and various wellsite data processing devices, e.g., devices 114A-H of FIG. 1, as described above. Network 208 in this example may be any type of network or combination of networks used to communicate information between different computing devices. Network 208 can include, but is not limited to, a wired (e.g., Ethernet) or a wireless (e.g., Wi-Fi or mobile telecommunications) network. Additionally, network 208 can include, but is not limited to, a local area network, medium area network, and/or wide area network such as the Internet.

In one or more embodiments, data analyzer 210 of system 200 may communicate via network 208 with each of wellsite data processing devices 114A-H to obtain information relating to downhole fluid properties and reservoir conditions during hydrocarbon production and/or stimulation operations at various wellsites in the field, as described above. Such information may include, for example, real-time measurements of pressure, volume and temperature for various reservoir fluids sampled by downhole measurement devices at different points (or “fluid sampling points”) along a wellbore drilled at each of the wellsites corresponding to wellsite data processing devices 114A-H. Data analyzer 210 may also retrieve PVT data resulting from different types of PVT lab tests (e.g., CCE, DL test, separator test, swell test, and/or CVD test). Such tests may be performed on downhole fluid samples collected at various depths within the same well or a nearby offset well drilled within the same hydrocarbon producing field. In some implementations, the PVT lab test data may be stored in a database 220 coupled to system 200. Database 220 may be any type of data storage device, e.g., in the form of a recording medium coupled to an integrated circuit that controls access to the recording medium. The recording medium can be, for example and without limitation, a semiconductor memory, a hard disk, or similar type of memory or storage device accessible to system 200. While not shown in FIG. 2, database 220 may also be implemented as a remote database communicatively coupled to system 200 via network 208.

In one or more embodiments, EOS modeler 212 may use the PVT lab data obtained by data analyzer 210 to determine a component grouping for an EOS model of the downhole fluids. The EOS model may be, for example, a non-linear correlation of fluid pressure, volume and temperature. The component grouping determined for the EOS model may include a selected number of fluid components for characterizing various properties of the downhole fluids. The selected components may then be combined in different ways to form a set of component groups for the EOS model. EOS modeler 212 may use real-time PVT measurements of reservoir fluid samples collected by downhole measurement devices or sensors over a plurality of sampling points along the wellbore to validate the component grouping that was previously determined for the EOS model using the PVT lab data as described above.

In one or more embodiments, reservoir simulator 214 may use the EOS model produced by EOS modeler 212 to estimate various physical properties of the fluids and how such properties may vary with temperature, pressure and compositional gradient during hydrocarbon downhole operations along a wellbore within the reservoir formation. For example, the EOS model may be used to estimate such fluid properties and perform compositional gradient calculations with respect these properties as part of a reservoir flow simulation by reservoir simulator 214. In addition to the selected fluid components and component groups, one or more EOS tuning parameters may be determined for optimizing or “tuning” the EOS model. Examples of such tuning parameters include, but are not limited to, binary interaction coefficients, critical PVT values, and any other EOS coefficients or parameters that may have theoretically or experimentally determined values. Accordingly, an EOS model may be tuned based on a combination of particular tuning parameters, number of fluid components and set of component groups, which not only define the EOS model but also impact the estimation of fluid properties and calculation of compositional gradients using the model during reservoir simulations.

As will be described in further detail below, the EOS model may be tuned during the simulation by reservoir simulator 214 by using machine learning to minimize the error between the fluid properties estimated using the model and those observed or measured during the downhole operations within the formation. For example, values of the fluid properties at different depths within the formation may be observed based on PVT lab tests performed on downhole fluid samples collected at corresponding points along a wellbore being drilled within the formation. The fluid samples may be collected over one or more stages of a downhole operation performed along a portion of the wellbore. Alternatively, the fluid samples may be collected from one or more nearby offset wells that were previously drilled within the same reservoir formation. In some implementations, the PVT data may be based on real-time measurements collected by downhole sensors within the wellbore during the downhole operation, as described above.

In one or more embodiments, tuning the EOS model may involve iteratively adjusting the component grouping for the EOS model over the course of the downhole operation along the wellbore until an error (e.g., a squared error or “fitting” error) between the EOS estimated and observed or measured downhole fluid properties (e.g., based on PVT lab test data or real-time measurements) is minimized. In some implementations, the component grouping for the EOS model may be iteratively adjusted using a machine learning model, e.g., a neural network, while the machine learning model is trained to minimize the error during a current stage of the downhole operation. For example, the machine learning model may be trained to minimize the error between properties of downhole fluids estimated using the EOS model and actual properties of the fluids as measured over a plurality of fluid sampling points along the wellbore during the current stage. The component grouping that was initially determined for the EOS model may be adjusted each time it is determined that the error between the estimated and actual fluid properties (e.g., based on real-time measurements acquired at each sampling point) exceeds a predetermined error tolerance value or range of values. The adjusted component grouping may then be used to tune the EOS model for subsequent stages of the downhole operation to be performed. The component grouping may be adjusted during the training and/or tuning process described above by changing the number of selected components or how the components are grouped. The particular component grouping determined for the EOS model may also affect the particular tuning parameters that are used to minimize the error of the model. Thus, tuning the EOS model may be viewed as an optimization problem that involves determining an optimal component grouping (e.g., optimal number of fluid components) and optimal tuning parameters, which minimizes the error of the EOS model's fluid property estimates or predictions.

In one or more embodiments, the error to be minimized may be represented by an objective function, e.g., as expressed by Equation (1):

$$\hat{p} = \begin{matrix}min \\ p\end{matrix} ( {\sum }_{t = 1}^{T} {( {d}_{t} - {d}_{t}^{EOS} ( p ) )}^{2} ) \qquad ( 1 )$$

where dₜ^{EOS} represents the EOS calculated data points (e.g., fluid properties estimated using the EOS model), dₜ represents the observed or measured data points (e.g., based on PVT lab tests) for t=1 to T fluid samples, T is total number of fluid samples available or selected for EOS tuning purposes, p generally represents values of one or more EOS tuning parameters (e.g., one or more binary interaction coefficients, critical PVT values, etc.), and \hat{p} represents a solution to Equation (1) for an optimal value of the EOS tuning parameter(s), which minimizes the fitting error of the EOS model.

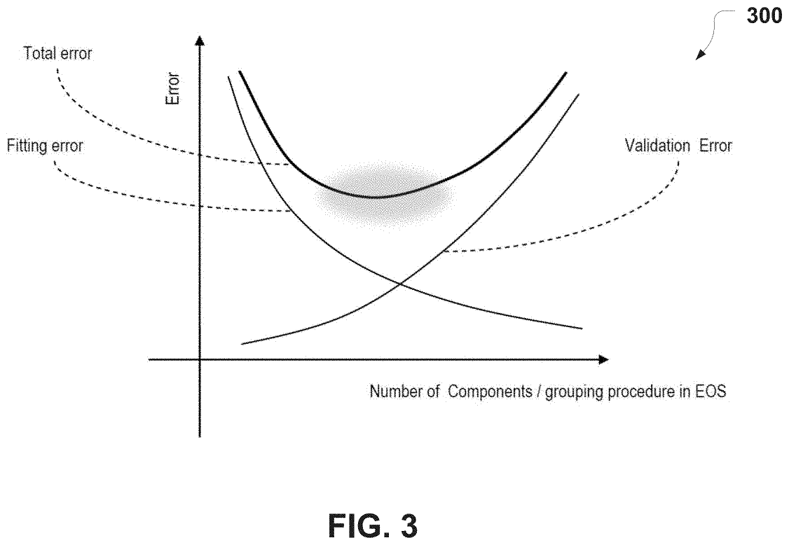

As shown in plot graph 300 of FIG. 3, the fitting error may decrease as the number of components used to characterize the downhole fluids increases. However, plot graph 300 also shows that increasing the number of components does not necessarily decrease the error in the predictions or estimates produced using the EOS model, also referred to herein as the validation error. While both the fitting error and the validation error apply to properties of fluid samples collected within a single wellbore, it should be appreciated that the fitting error is measured against a test or training dataset (e.g., PVT lab data) while the validation error is measured against real-time data (e.g., real-time PVT measurements collected downhole).

In one or more embodiments, a portion of the PVT data obtained by data analyzer 210 may be used to calculate the fitting error and a remaining portion may be used to calculate the validation/prediction error while minimizing a total error of the EOS model. For example, Equation (1) above may be modified to calculate the fitting error for the EOS model using only a portion of the PVT data, e.g., based on only a certain number of downhole fluid samples. Equation (2) below is an example of a modified version of Equation (1) for calculating the fitting error (FE) for only t_{FIT} samples, where t_{FIT} may be any number or value selected as desired for a particular implementation:

FE=Σₜ₌₁^{t}^{_{FIT}}(dₜ−dₜ^{EOS}(p))² (2)

Equation (2) above may be minimized in order to determine the optimal tuning parameter value \hat{p}, which can then be used to calculate the validation error (VE), e.g., using Equation (3):

VE=Σ_{t≠t}_{_{FIT}}(d_{t≠t}_{_{FIT}}−d_{t≠t}_{_{FIT}}^{EOS}(\hat{p}))² (3)

where t≠t_{FIT} represents all of the remaining samples not included in the t_{FIT} samples used for the calculation of the fitting error using Equation (2) above. Accordingly, a total error (TE) for the EOS model may be calculated based on the fitting error and the validation error, e.g., as expressed by Equation (4):

TE=FE+VE (4)

In one or more embodiments, reservoir simulator 214 may use machine learning to determine an optimal component grouping, including an optimal number of components as well as optimal combinations of those components for different component groups, and optimal EOS tuning parameters, which minimize the total error of the EOS model being tuned, e.g., using Equation (5):

min(Σₜ₌₁^{t}^{_{FIT}}(dₜ−dₜ^{EOS}(p))²+Σ_{t≠t}_{_{FIT}}(d_{t≠t}_{_{FIT}}−d_{t≠t}_{_{FIT}}^{EOS}(\hat{p}))²) (5)

The optimal component grouping determined for the EOS model may then be used to determine the optimal tuning parameter (\hat{p}) using Equation (1) above and all of the available PVT data (corresponding to all T fluid samples, including both t_{FIT} and t≠t_{FIT} samples), e.g., as obtained by data analyzer 210 from DB 220 or at least one of wellsite data processing devices 114A-H or a combination thereof.

In one or more embodiments, the particular fluid samples (t_{FIT}) selected for the fitting error calculation using Equation (2) as opposed to the samples (t≠t_{FIT}) selected or reserved for the validation error calculation using Equation (3) may vary based on the available PVT data and degree of accuracy desired for a particular implementation. For example, samples selected for the fitting error may be those having PVT data value that are within a predetermined range of average values considered to be reasonable for the particular implementation in order to avoid data outliers.

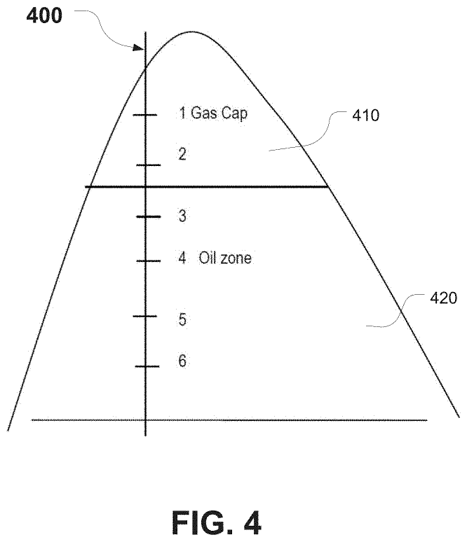

In FIG. 3, plot graph 300 illustrates an example of fitting, validation, and total error trends for tuning an EOS model as a function of the component grouping, including the number of fluid components and type of component grouping, used in the tuning process, e.g., based on the iterative adjustments that were made to minimize the total error of the EOS model over the course of the downhole operation along the wellbore as described above. In one or more embodiments, the PVT data or corresponding fluid samples used to derive the fitting, validation and total error trends in this example may be collected by a downhole tool at various depths or locations along a wellbore drilled through different areas of the reservoir formation during the downhole operation, where each area may have different types of fluid deposits, as illustrated by the example in FIG. 4.

FIG. 4 is a schematic of a wellbore 400 within a reservoir formation having a gas cap 410 and an oil zone 420. Although wellbore 400 is shown in FIG. 4 as a vertical wellbore, it should be appreciated that the disclosed techniques are not limited thereto and that these techniques may also be applied to horizontal or deviated wellbores. In one or more embodiments, fluid samples may be collected at various points along wellbore 400 during downhole operations within the reservoir formation. For example, fluid samples may be collected at depths corresponding to each of gas cap 410 and oil zone 420. PVT data for the collected fluid samples, either based on measurements from downhole sensors or from PVT lab test results, may be used to derive the fitting, validation and total error trends for an EOS model being tuned, as described above. In one or more embodiments, the PVT data corresponding to a portion of the fluid samples (e.g., samples collected at depths 1, 3 and 5 along wellbore 400) may be used for determining the fitting error of the EOS model, e.g., using Equation (2), as described above. The remaining PVT data corresponding to a remaining portion of the samples (e.g., samples collected at depths 1, 3 and 5 along wellbore 400) may be used for determining the model's validation error, e.g., using Equation (3), as described above.

Referring back to FIG. 2, once the total error is minimized using the above-described tuning techniques, reservoir simulator 214 may use the tuned EOS model to estimate fluid properties for additional stages of the downhole operation to be performed along the wellbore within the reservoir formation. In one or more embodiments, wellsite controller 216 may use the estimated properties to determine appropriate values for one or more controllable parameters of the downhole operation. Such controllable parameters may include, for example and without limitation, a weight-on-bit and drilling speed (e.g., in revolutions per minute or RPM) for drilling stages along with a fluid injection or pumping rate and other injection parameters for injection or stimulation stages of the downhole operation being performed. Further, wellsite controller 216 may send appropriate commands or instructions, including the determined parameter values, for performing the additional stages of the operation to SCADA system 206 via network 208. SCADA system 206 may interpret the commands/instructions received from wellsite controller 216 and direct one or more of wellsite data processing devices 114A-H or other wellsite equipment to perform the additional stages of the downhole operation accordingly. However, it should be appreciated that wellsite controller 216 in some implementations may communicate the commands/instructions (including the values of controllable parameters) for performing the downhole operation directly to wellsite data processing devices 114A-H or other wellsite equipment via network 208.

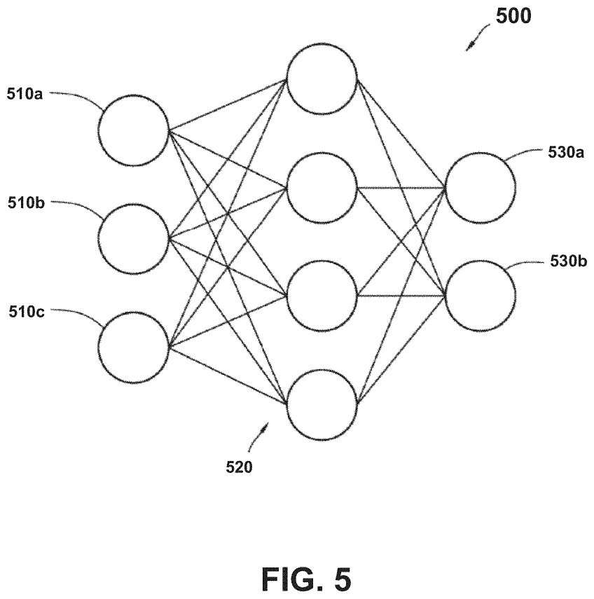

In one or more embodiments, the machine learning model may be an artificial neural network, e.g., a deep learning neural network, as will be described in further detail below with respect to FIG. 5. However, it should be appreciated that embodiments of the present disclosure are not intended to be limited thereto and that other types of machine learning models may be used as desired for a particular implementation.

FIG. 5 is a diagram of an illustrative neural network 500. As shown in FIG. 5, neural network 500 includes a plurality of input nodes 510a, 510b, and 510c (“input nodes 510a-c”). Input nodes 510a-c may represent points within an input layer of neural network 500 at which input parameters for different field operations are provided for processing and calculations within a hidden layer 520 of neural network 500. Hidden layer 520 includes hidden nodes, where each hidden node may be coupled to some or all of input nodes 510a-c. The results of the processing and calculations within hidden layer 520 may include output parameters that are produced at output nodes 530a and 530b (“output nodes 530a-b”) of an output layer of neural network 500.

In one or more embodiments, each of the hidden nodes of hidden layer 520 may perform a set of mathematical functions or operations for tuning an EOS model by minimizing the fitting error and validation error (or total error) of the model, e.g., using Equations (1)-(5), as described above. The optimal parameters for the respective mathematical functions/operations may be determined or learned during a training phase of neural network 500. The mathematical operations may be performed based on PVT data provided at the particular input node(s) to which the hidden node is coupled. Likewise, output nodes 530a-b may perform mathematical operations based on data provided from the hidden nodes of hidden layer 520. Accordingly, each of output nodes 530a-b may represent an estimated or predicted output parameter based on the input parameter data provided at input nodes 510a-c. While three input nodes 510a-c and two output nodes 530a-b are shown in FIG. 5, it should be appreciated that neural network 500 may include any number of input and output nodes, as desired for a particular implementation. Also, while only layer 520 is shown in FIG. 5, it should be appreciated that neural network 500 may include any number of additional hidden layers, where each hidden layer may include any number of hidden nodes, as desired for a particular implementation.

In one or more embodiments, neural network 500 may be provided with real-time PVT data relating to fluid samples collected in the field. From the values provided to input nodes 510a-c, neural network 500 may produce values for output parameters at output nodes 530a-b. Such output values may include estimated properties of various downhole fluids within a reservoir formation along with optimal component groupings for the EOS model.

Referring back to FIG. 2, neural network 500 of FIG. 5 or other machine learning model used by reservoir simulator 214 may be updated periodically based on additional PVT data obtained for fluid samples from one or more wells in the hydrocarbon producing field over time. In some implementations, the additional data from the field may be acquired in real-time, e.g., by system 200 via SCADA system 206 or directly from one or more of wellsite data processing devices 114A-H over communication network 208. The data may be processed and applied to the machine learning model as the data is acquired, e.g., by data analyzer 210 in order to produce updated estimates of fluid properties or predictions of the PVT behavior of the downhole fluids during additional downhole operations to be performed within the reservoir formation. The results of such predictive modeling may be used to make adjustments to an existing well plan or fluid treatment schedule used to perform the downhole operations.

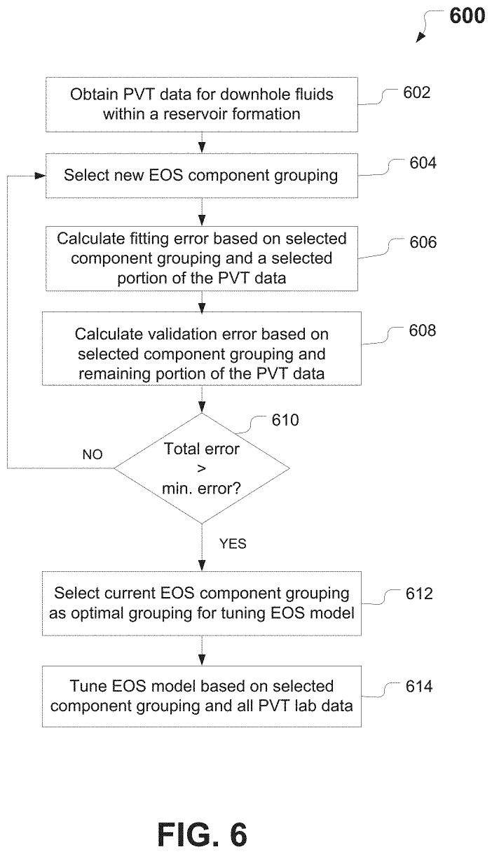

FIG. 6 is a flowchart of an illustrative process 600 for optimizing EOS models with machine learning for improved reservoir flow simulations and prediction of reservoir fluid properties. For discussion purposes, process 600 will be described with reference to system 200 of FIG. 2, as described above. However, process 600 is not intended to be limited thereto. In one or more embodiments, a machine learning model, such as an artificial neural network, e.g., neural network 500 of FIG. 5, as described above, may be used in combination with PVT data acquired from both lab tests and downhole measurements from a wellsite to perform the various functions and operations associated with process 600, as will be described in further detail below.

As shown in FIG. 6, process 600 begins in block 602, which includes obtaining PVT data for downhole fluids within a reservoir formation. The PVT data may be used in block 604 to select a component grouping for an EOS model to be tuned.

In block 606, a fitting error may be calculated for the EOS model based on a difference between the fluid properties estimated using the EOS model according to the selected component grouping and actual fluid properties according to a selected portion of the PVT data.

In block 608, a validation error may be calculated based on a difference between the fluid properties estimated using the EOS model according to the selected component grouping and actual fluid properties according to the remaining portion of the PVT data. The validation error calculated in block 608 and the fitting error calculated in block 606 may then be used to calculate a total error for the EOS model.

In block 610, a determination is made as to whether or not the total error of the EOS model exceeds a minimum error threshold. The minimum error threshold may be, for example, any predetermined value corresponding to a minimum of a value range representing an error tolerance for the EOS model being tuned. It should be appreciated that any error tolerance value may be used as desired for a particular implementation.

If it is determined in block 610 that the total error exceeds the minimum error threshold, process 600 returns to block 604, in which the EOS component grouping of the EOS model is adjusted, e.g., by selecting a new EOS component grouping for the EOS model. The operations in blocks 606, 608 and 610 are repeated until the total error is minimized, i.e., it is determined in block 610 that the total error does not exceed the minimum error threshold, in which case process 600 may proceed to block 612.

In block 612, the current EOS component grouping is selected as the optimal component grouping for the EOS model to be tuned.

In block 614, the EOS model is tuned based on the optimal component grouping selected in block 612 and all of the PVT data obtained in block 602 for the EOS model. Tuning the EOS model in block 614 may include, for example, first determining the EOS tuning parameter(s) for the model, e.g., using Equation (1), as described above, and then using the determined tuning parameters to tune the model.

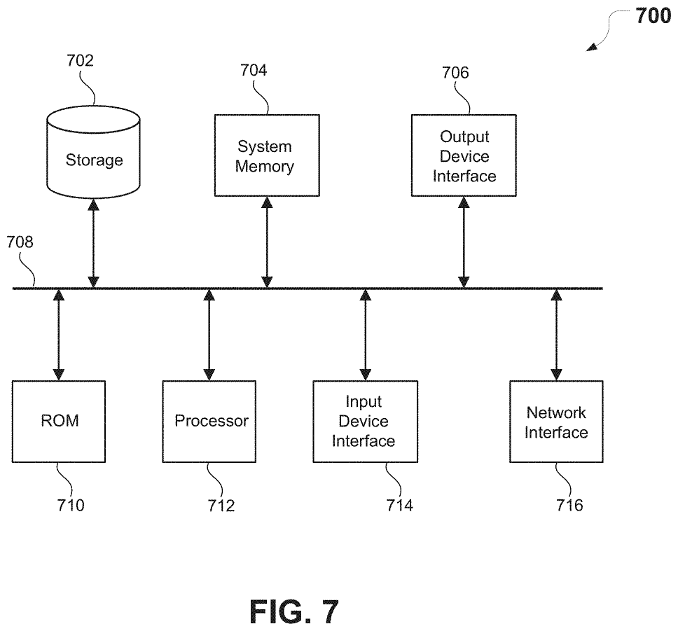

FIG. 7 is a block diagram of an illustrative computer system 700 in which embodiments of the present disclosure may be implemented. For example, the functions and operations of computer system 200 of FIG. 2 and process 600 of FIG. 6, as described above, may be implemented using system 700. System 700 can be a computer, phone, PDA, or any other type of electronic device. Such an electronic device includes various types of computer readable media and interfaces for various other types of computer readable media. As shown in FIG. 7, system 700 includes a permanent storage device 702, a system memory 704, an output device interface 706, a system communications bus 708, a read-only memory (ROM) 710, processing unit(s) 712, an input device interface 714, and a network interface 716.

Bus 708 collectively represents all system, peripheral, and chipset buses that communicatively connect the numerous internal devices of system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of system 700. Permanent storage device 702, on the other hand, is a read-and-write memory device. This device is a non-volatile memory unit that stores instructions and data even when system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for EOS model tuning in accordance with embodiments of the present disclosure, e.g., according to process 600 of FIG. 6, as described above. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the system 700. Input devices used with input device interface 714 include, for example, alphanumeric, QWERTY, or T9 keyboards, microphones, and pointing devices (also called “cursor control devices”). Output device interfaces 706 enables, for example, the display of images generated by the system 700. Output devices used with output device interface 706 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 7, bus 708 also couples system 700 to a public or private network (not shown) or combination of networks through a network interface 716. Such a network may include, for example, a local area network (“LAN”), such as an Intranet, or a wide area network (“WAN”), such as the Internet. Any or all components of system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, process 600 of FIG. 6, as described above, may be implemented using system 700 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

As described above, embodiments of the present disclosure are particularly useful for tuning equation of state (EOS) characterizations, e.g., for purposes of reservoir simulations and well planning. In one embodiment of the present disclosure, a computer-implemented method for tuning equation of state (EOS) characterizations includes: obtaining pressure-volume-temperature (PVT) data for downhole fluids within a reservoir formation; determining a component grouping for an EOS model of the downhole fluids, based on the obtained PVT data, the component grouping including a selected number of fluid components; estimating properties of the downhole fluids for a current stage of a downhole operation along a wellbore within the reservoir formation, based on the component grouping determined for the EOS model; training a machine learning model to minimize an error between the estimated properties of the downhole fluids and actual properties of the downhole fluids as measured along the wellbore during the current stage of the downhole operation, wherein the component grouping for the EOS model is iteratively adjusted by the machine learning model until the error is minimized during the current stage of the downhole operation; tuning the EOS model using the component grouping as adjusted by the trained machine learning model during the current stage of the downhole operation; estimating fluid properties for one or more subsequent stages of the downhole operation to be performed along the wellbore, based on the tuned EOS model; and performing the one or more subsequent stages of the downhole operation, based on the estimated fluid properties.

Likewise, embodiments of a computer-readable storage medium having instructions stored therein have been described, where the instructions, when executed by a processor, may cause the processor to perform a plurality of functions, including functions to: obtain pressure-volume-temperature (PVT) data for downhole fluids within a reservoir formation; determine a component grouping for an EOS model of the downhole fluids, based on the obtained PVT data, the component grouping including a selected number of fluid components; estimate properties of the downhole fluids for a current stage of a downhole operation along a wellbore within the reservoir formation, based on the component grouping determined for the EOS model; train a machine learning model to minimize an error between the estimated properties of the downhole fluids and actual properties of the downhole fluids as measured along the wellbore during the current stage of the downhole operation, wherein the component grouping for the EOS model is iteratively adjusted by the machine learning model until the error is minimized during the current stage of the downhole operation; tune the EOS model using the component grouping as adjusted by the trained machine learning model during the current stage of the downhole operation; estimate fluid properties for one or more subsequent stages of the downhole operation to be performed along the wellbore, based on the tuned EOS model; and perform the one or more subsequent stages of the downhole operation, based on the estimated fluid properties.

The foregoing embodiments of the method or computer-readable storage medium may include any one or any combination of the following elements, features, functions, or operations: the estimated fluid properties are selected from the group consisting of viscosity, density, formation volume factor, and fluid phase properties; the fluid properties are estimated based on a simulation of fluid flow within the reservoir formation using the tuned EOS model; the error is a total error calculated for the EOS model, and the total error includes a fitting error and a validation error; the tuning includes calculating the fitting error and the validation error based on the obtained PVT data, calculating the total error based on the fitting error and the validation error, determining whether or not the total error exceeds a minimum error threshold, and when it is determined that the total error exceeds the minimum error threshold, adjusting the component grouping determined for the EOS model, recalculating the fitting error based on the adjusted component grouping, and repeating the adjusting and the recalculating until it is determined that the total error does not to exceed the minimum error threshold; obtaining the PVT data further includes obtaining PVT data based on samples of the downhole fluids collected at a plurality of sampling points along the wellbore during the current stage of the downhole operation, selecting a first portion of the PVT data for calculating the fitting error, and selecting a second portion of the PVT data for calculating the validation error; calculating the fitting error includes calculating a difference between the estimated properties of the downhole fluids and the actual fluid properties based on the component grouping and the first portion of the PVT data selected for the fitting error calculation, and calculating, using the machine learning model, the fitting error to be minimized for the EOS model based on the calculated difference; and calculating the validation error includes calculating a difference between the estimated properties of the downhole fluids and the actual fluid properties based on the component grouping and the second portion of the PVT data selected for the validation error calculation and calculating, using the machine learning model, the validation error to be minimized for the EOS model based on the calculated difference.

Furthermore, embodiments of a system including at least one processor and a memory coupled to the processor have been described, where the memory stores instructions, which, when executed by a processor, may cause the processor to perform a plurality of functions, including functions to: obtain pressure-volume-temperature (PVT) data for downhole fluids within a reservoir formation; determine a component grouping for an EOS model of the downhole fluids, based on the obtained PVT data, the component grouping including a selected number of fluid components; estimate properties of the downhole fluids for a current stage of a downhole operation along a wellbore within the reservoir formation, based on the component grouping determined for the EOS model; train a machine learning model to minimize an error between the estimated properties of the downhole fluids and actual properties of the downhole fluids as measured along the wellbore during the current stage of the downhole operation, wherein the component grouping for the EOS model is iteratively adjusted by the machine learning model until the error is minimized during the current stage of the downhole operation; tune the EOS model using the component grouping as adjusted by the trained machine learning model during the current stage of the downhole operation; estimate fluid properties for one or more subsequent stages of the downhole operation to be performed along the wellbore, based on the tuned EOS model; and perform the one or more subsequent stages of the downhole operation, based on the estimated fluid properties.

The foregoing embodiments of the system may include any one or any combination of the following elements, features, functions, or operations: the estimated fluid properties are selected from the group consisting of viscosity, density, formation volume factor, and fluid phase properties; the fluid properties are estimated based on a simulation of fluid flow within the reservoir formation using the tuned EOS model; the error is a total error calculated for the EOS model, and the total error includes a fitting error and a validation error; calculating the fitting error and the validation error based on the obtained PVT data, calculating the total error based on the fitting error and the validation error, determining whether or not the total error exceeds a minimum error threshold, and when it is determined that the total error exceeds the minimum error threshold, adjusting the component grouping determined for the EOS model, recalculating the fitting error based on the adjusted component grouping, and repeating the adjusting and the recalculating until it is determined that the total error does not to exceed the minimum error threshold, obtaining PVT data based on samples of the downhole fluids collected at a plurality of sampling points along the wellbore during the current stage of the downhole operation, selecting a first portion of the PVT data for calculating the fitting error, and selecting a second portion of the PVT data for calculating the validation error; calculating the fitting error by calculating a difference between the estimated properties of the downhole fluids and the actual fluid properties based on the component grouping and the first portion of the PVT data selected for the fitting error calculation, and calculating, using the machine learning model, the fitting error to be minimized for the EOS model based on the calculated difference; and calculating the validation error by calculating a difference between the estimated properties of the downhole fluids and the actual fluid properties based on the component grouping and the second portion of the PVT data selected for the validation error calculation and calculating, using the machine learning model, the validation error to be minimized for the EOS model based on the calculated difference.

While specific details about the above embodiments have been described, the above hardware and software descriptions are intended merely as example embodiments and are not intended to limit the structure or implementation of the disclosed embodiments. For instance, although many other internal components of the system 700 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A computer-implemented method for tuning equation of state (EOS) characterizations, the method comprising:
obtaining pressure-volume-temperature (PVT) data for downhole fluids within a reservoir formation;
determining a component grouping for an EOS model of the downhole fluids, based on the obtained PVT data, the component grouping including a selected number of fluid components;
estimating properties of the downhole fluids for a current stage of a downhole operation along a wellbore within the reservoir formation, based on the component grouping determined for the EOS model;
training a machine learning model to minimize an error between the estimated properties of the downhole fluids and actual properties of the downhole fluids as measured along the wellbore during the current stage of the downhole operation, wherein the component grouping for the EOS model is iteratively adjusted by the machine learning model until the error is minimized during the current stage of the downhole operation;
tuning the EOS model using the component grouping as adjusted by the trained machine learning model during the current stage of the downhole operation;
estimating fluid properties for one or more subsequent stages of the downhole operation to be performed along the wellbore, based on the tuned EOS model; and
performing the one or more subsequent stages of the downhole operation, based on the estimated fluid properties.

2. The method of claim 1, wherein the estimated fluid properties are selected from the group consisting of viscosity, density, formation volume factor, and fluid phase properties.

3. The method of claim 1, wherein the fluid properties are estimated based on a simulation of fluid flow within the reservoir formation using the tuned EOS model.

4. The method of claim 1, wherein the error is a total error calculated for the EOS model, and the total error includes a fitting error and a validation error.

5. The method of claim 4, wherein the tuning comprises:
calculating the fitting error and the validation error based on the obtained PVT data;
calculating the total error based on the fitting error and the validation error;
determining whether or not the total error exceeds a minimum error threshold; and
when it is determined that the total error exceeds the minimum error threshold:
adjusting the component grouping determined for the EOS model;
recalculating the fitting error based on the adjusted component grouping; and
repeating the adjusting and the recalculating until it is determined that the total error does not to exceed the minimum error threshold.

6. The method of claim 5, wherein obtaining the PVT data further comprises:
obtaining PVT data based on samples of the downhole fluids collected at a plurality of sampling points along the wellbore during the current stage of the downhole operation;
selecting a first portion of the PVT data for calculating the fitting error; and
selecting a second portion of the PVT data for calculating the validation error.

7. The method of claim 6, wherein calculating the fitting error comprises:
calculating a difference between the estimated properties of the downhole fluids and the actual fluid properties, based on the component grouping and the first portion of the PVT data selected for the fitting error calculation; and
calculating, using the machine learning model, the fitting error to be minimized for the EOS model based on the calculated difference.

8. The method of claim 6, wherein calculating the validation error comprises:
calculating a difference between the estimated properties of the downhole fluids and the actual fluid properties, based on the component grouping and the second portion of the PVT data selected for the validation error calculation; and
calculating, using the machine learning model, the validation error to be minimized for the EOS model based on the calculated difference.

9. A system comprising:
a processor; and
a memory coupled to the processor, the memory having instructions stored therein, which, when executed by the processor, cause the processor to perform a plurality of functions, including functions to:
obtain pressure-volume-temperature (PVT) data for downhole fluids within a reservoir formation;
determine a component grouping for an EOS model of the downhole fluids, based on the obtained PVT data, the component grouping including a selected number of fluid components;
estimate properties of the downhole fluids for a current stage of a downhole operation along a wellbore within the reservoir formation, based on the component grouping determined for the EOS model;
train a machine learning model to minimize an error between the estimated properties of the downhole fluids and actual properties of the downhole fluids as measured along the wellbore during the current stage of the downhole operation, wherein the component grouping for the EOS model is iteratively adjusted by the machine learning model until the error is minimized during the current stage of the downhole operation;
tune the EOS model using the component grouping as adjusted by the trained machine learning model during the current stage of the downhole operation;
estimate fluid properties for one or more subsequent stages of the downhole operation to be performed along the wellbore, based on the tuned EOS model; and
perform the one or more subsequent stages of the downhole operation, based on the estimated fluid properties.

10. The system of claim 9, wherein the estimated fluid properties are selected from the group consisting of viscosity, density, formation volume factor, and fluid phase properties.

11. The system of claim 9, wherein the fluid properties are estimated based on a simulation of fluid flow within the reservoir formation using the tuned EOS model.

12. The system of claim 9, wherein the error is a total error calculated for the EOS model, and the total error includes a fitting error and a validation error.

13. The system of claim 12, wherein the functions performed by the processor further include functions to:
calculate the fitting error and the validation error based on the obtained PVT data;
calculate the total error based on the fitting error and the validation error;
determine whether or not the total error exceeds a minimum error threshold; and
when it is determined that the total error exceeds the minimum error threshold:
adjust the component grouping determined for the EOS model;
recalculate the fitting error based on the adjusted component grouping; and
repeat the adjusting and the recalculating until it is determined that the total error does not to exceed the minimum error threshold.

14. The system of claim 13, wherein the functions performed by the processor further include functions to:
obtain PVT data based on samples of the downhole fluids collected at a plurality of sampling points along the wellbore during the current stage of the downhole operation;
select a first portion of the PVT data for calculating the fitting error; and
select a second portion of the PVT data for calculating the validation error.

15. The system of claim 14, wherein the functions performed by the processor further include functions to:
calculate a difference between the estimated properties of the downhole fluids and the actual fluid properties, based on the component grouping and the first portion of the PVT data selected for the fitting error calculation; and
calculate, using the machine learning model, the fitting error to be minimized for the EOS model based on the calculated difference.

16. The system of claim 14, wherein the functions performed by the processor further include functions to:
calculate a difference between the estimated properties of the downhole fluids and the actual fluid properties, based on the component grouping and the second portion of the PVT data selected for the validation error calculation; and
calculate, using the machine learning model, the validation error to be minimized for the EOS model based on the calculated difference.

17. A computer-readable storage medium having instructions stored therein, which, when executed by a computer, cause the computer to perform a plurality of functions, including functions to:
obtain pressure-volume-temperature (PVT) data for downhole fluids within a reservoir formation;
determine a component grouping for an EOS model of the downhole fluids, based on the obtained PVT data, the component grouping including a selected number of fluid components;
estimate properties of the downhole fluids for a current stage of a downhole operation along a wellbore within the reservoir formation, based on the component grouping determined for the EOS model;
train a machine learning model to minimize an error between the estimated properties of the downhole fluids and actual properties of the downhole fluids as measured along the wellbore during the current stage of the downhole operation, wherein the component grouping for the EOS model is iteratively adjusted by the machine learning model until the error is minimized during the current stage of the downhole operation;
tune the EOS model using the component grouping as adjusted by the trained machine learning model during the current stage of the downhole operation;
estimate fluid properties for one or more subsequent stages of the downhole operation to be performed along the wellbore, based on the tuned EOS model; and
perform the one or more subsequent stages of the downhole operation, based on the estimated fluid properties.

18. The computer-readable storage medium of claim 17, wherein the estimated fluid properties are selected from the group consisting of viscosity, density, formation volume factor, and fluid phase properties.

19. The computer-readable storage medium of claim 17, wherein the fluid properties are estimated based on a simulation of fluid flow within the reservoir formation using the tuned EOS model.

20. The computer-readable storage medium of claim 17, wherein the error is a total error calculated for the EOS model, and the total error includes a fitting error and a validation error.
